(19) United States
(12) Patent Application Publication
(10) Pub. No.: US 2025/0321415 A1
(43) Pub. Date: Oct. 16, 2025

(54) ROTATING MIRROR LASER SCANNER

(71) Applicant: Wuhan DR Laser Technology Corp,. LTD, Wuhan (CN)

(72) Inventors: Eldad ALBER, Rehovot (IL); Eyal COHEN, Kfar Saba (IL); Baruch EINZIGER, Gan Yavne (IL); Moshe FINAROV, Rehovot (IL); Tal MARCU, Mevaseret Zion (IL); Mark Robin SHERIDAN, Hod Hasharon (IL)

(73) Assignee: Wuhan DR Laser Technology Corp,. LTD, Wuhan (CN)

(21) Appl. No.: 19/077,526

(22) Filed: Mar. 12, 2025

(30) Foreign Application Priority Data
Apr. 15, 2024 (CN) 202410446386.2
Apr. 15, 2024 (CN) 202420782171.3

(51) Int. Cl. G02B 26/10

(52) U.S. Cl. CPC G02B 26/10

(57) ABSTRACT

Laser scanners are provided for scanning laser radiation from a laser source onto a target. The laser scanners include a mirror having a reflective plane configured to reflect the laser radiation from the laser source onto the target, a holder with a rotating axis for mounting the mirror with the rotating axis at the reflective plane of the mirror, and a motor configured to rotate the holder with the mirror around the rotating axis. The configuration of the rotating mirror allows fast and accurate scanning of narrow features by the reflected laser radiation, such as thin paste-filled trenches in pattern transfer sheets for printing. Various mechanisms are provided to ensure accuracy and stability of the laser scanners, and to incorporate them within pattern transfer printing systems.

### BACKGROUND OF THE INVENTION

### 1. Technical Field

The present invention relates to the fields of laser scanning and pattern transfer printing, and more particularly, to accurately scanning laser radiation across targets, using a rotating mirror assembly.

### 2. Discussion of Related Art

Stutz, G. E. (2012) “Polygonal Scanners: Components, Performance, and Design”, Chapter 4 in Handbook of Optical and Laser Scanning, G. F. Marshall and G. E. Stutz (Eds.), CRC Press, provides background relating to various types of beam scanning devices, such as polygon mirrors, resonant mirrors, acoustical-optical deflectors, galvanometric mirrors, MEMS (micro-electromechanical systems) mirrors and spinning mirrors, each having their advantages and disadvantages.

U.S. Pat. Nos. 4,870,274, 4,838,632 and 4,699,447, which are incorporated herein by reference in their entirety, teach various types of beam scanners with rotating mirrors.

### SUMMARY OF THE INVENTION

The following is a simplified summary providing an initial understanding of the invention. The summary does not necessarily identify key elements nor limit the scope of the invention, but merely serves as an introduction to the following description.

In one aspect, the invention is embodied as a laser scanner that receives laser radiation from a laser source, the laser scanner comprising: a mirror having a reflective plane configured to reflect the laser radiation from the laser source onto a target; a holder having a rotating axis, wherein the mirror is mounted on the holder with the rotating axis being at the reflective plane of the mirror; and a motor configured to rotate the holder with the mirror around the rotating axis, wherein a center of mass of the holder with the mounted mirror is located on the rotating axis.

In embodiments, the laser scanner comprises specified regions on a backside of the holder for adding or removing material to balance the holder with the mounted mirror about the rotating axis at the reflective plane of the mirror.

In embodiments, the laser scanner further comprises a stabilization disk mounted on the rotating axis having a moment of inertia larger than a moment of inertia of the holder with the mounted mirror.

In embodiments, the laser scanner further comprises: a thru-beam sensor to control operation of the laser source; and a control disk that is mounted on the rotating axis and has a periphery that interrupts the thru-beam sensor over a specified angular range during rotation of the disk, wherein the control disk, except for the specified angular range, is configured to interrupt the thru-beam sensor at angles in which the mirror is not required to reflect the laser radiation for scanning, and the interrupted thru-beam sensor disables the laser source.

In embodiments, the laser scanner further comprises a thru-beam sensor to control operation of the laser source and a control disk that is mounted on the rotating axis and has a periphery that interrupts the thru-beam sensor over a specified angular range during rotation of the disk, wherein the control disk, except for the specified angular range, is configured to interrupt the thru-beam sensor at angles in which the mirror is required to reflect the laser radiation for scanning, and the interrupted thru-beam sensor enables the laser source.

In embodiments, the laser scanner further comprises a temporarily-used alignment fixture to temporarily affix the mirror in a zero angular position during a scanner alignment stage, in which laser beam location calibration is carried out relative to a scanned line.

In embodiments, the laser scanner according to the invention is set within an enclosure with an inlet for purging an internal volume of the laser scanner with clean air or gas.

In embodiments of the invention, rotating the mirror about the rotating axis is employed for fast scanning, and the laser scanner further comprises a mechanical motion system to move the scanner for scanning along an orthogonal slow scanning axis to yield two-dimensional scanning.

In another aspect, the invention is as pattern transfer printing (PTP) system comprising the laser scanner described above, configured to scan tape trenches filled by a paste.

In another aspect, the invention is embodied in a method of scanning laser radiation from a laser source onto a target, the method comprising: mounting a mirror onto a holder, wherein the mirror has a reflective plane and the holder has a rotating axis at the reflective plane of the mirror; rotating the holder with the mirror around the rotating axis to reflect the laser radiation from the laser source onto the target by the reflective plane; and locating a center of mass of the holder with the mounted mirror on the rotating axis.

In embodiments, the method further comprises balancing the holder with the mounted mirror about the rotating axis at the reflective plane of the mirror by adding or removing material at specified regions on a backside of the holder.

In embodiments, the method further comprises stabilizing the rotating axis by a stabilization disk that is mounted thereon, and has a larger moment of inertia than the holder and the mounted mirror.

In embodiments, the method further comprises controlling operation of the laser source by a thru-beam sensor, and mounting a control disk on the rotating axis to interrupt the thru-beam sensor over a specified angular range during rotation of the disk, in which the mirror is not required to reflect the laser radiation for scanning, wherein the interrupting of the thru-beam sensor disables the laser source.

In embodiments, the method further comprises temporarily affixing the mirror in a zero angular position during a scanner alignment stage, in which laser beam location calibration is carried out relative to a scanned line.

In embodiments, the method further comprises setting at least the mirror, the holder and at least part of the rotating axis within an enclosure with an inlet, and purging an internal volume of the enclosure via the inlet with clean air or gas.

The method may further comprise scanning in two directions by: rotating the mirror about the rotating axis for fast scanning, and moving at least the mirror, the holder and at least part of the rotating axis for scanning along an orthogonal slow scanning axis.

In embodiments, the method further comprises implementing the scanning of the laser radiation from the laser source onto the target as part of a pattern transfer printing (PTP) system, wherein the target comprises tape trenches filled by a paste.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIGS. 1A, 1B and 2 are high-level schematic illustrations of laser scanners, according to some embodiments of the invention.

FIGS. 3A and 3B are high-level schematic illustrations of a laser scanner with an alignment fixture, according to some embodiments of the invention.

FIG. 4 is a high-level schematic illustration of a laser scanner comprising an enclosure, according to some embodiments of the invention.

FIG. 5 is a high-level flowchart illustrating a method of scanning laser radiation, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Some embodiments of the present invention provide efficient and economical methods and mechanisms for accurately scanning laser radiation across targets, and thereby provide improvements to the technological fields of laser scanning and pattern transfer printing. Laser scanners are provided for scanning laser radiation from a laser source onto a target. The laser scanners include a mirror having a reflective plane configured to reflect the laser radiation from the laser source onto the target, a holder with a rotating axis for mounting the mirror with the rotating axis at the reflective plane of the mirror, and a motor configured to rotate the holder with the mirror—around the rotating axis. The configuration of the rotating mirror allows fast and accurate scanning of narrow features by the reflected laser radiation, such as thin paste-filled trenches in pattern transfer sheets for printing. Various mechanisms are provided to ensure accuracy and stability of the laser scanners, and to incorporate them within pattern transfer printing systems.

Disclosed embodiments provide accurate weight balance (alignment of the rotating assembly center of mass with the rotating axis) by using a mechanical design that (i) enables accurate balancing (disbalance compensation) by compensating for shifting of the center of mass of the mirror to one side of the rotating axis by an equivalent shift of the center of mass of the mirror holder to an opposite side of the rotating axis at both sides along the axis; and (ii) includes specified regions (e.g., two dedicated depressions), which enable adding or removing small amounts of material for enhancing the accuracy of the balance. During production and testing, accurate balancing is achieved by a balancing process that utilizes these design features, e.g., by measuring the degree of balancing, calculating the amount of material to be added to achieve full balancing, adding this amount of material into the dedicated depressions in the mirror holder and drying the mirror holder until the material is solidified and combined with the holder material, and if material removal is required, drilling through the dedicated depressions to achieve accurate balancing.

Advantageously, disclosed embodiments locate the rotating axis exactly on the mirror surface, preventing shortcomings of prior art designs such as shifting the mirror center of mass off the rotating axis, mirror distortion during high-speed rotation, non-uniform pressure on motor shaft or bearings during a rotation with associated vibrations and increased mechanical wearing. Disclosed embodiments also have a high moment of inertia that reduces sensitivity to vibrations and provides stability over a wide range of scanning frequencies, while not requiring complex motor control for stabilization, as is required in prior art designs. Moreover, disclosed embodiments control the timing of the laser source with respect to the position of the mirror, switching on the laser only within a certain angular range of the spinning mirror, but without requiring a complicated timing control system as required in prior art designs. Finally, disclosed embodiments enable aligning the laser beam location relative to the scanned area as well as preventing contamination of the mirror surface, e.g., by dust particles—thereby reducing or avoiding laser beam scattering.

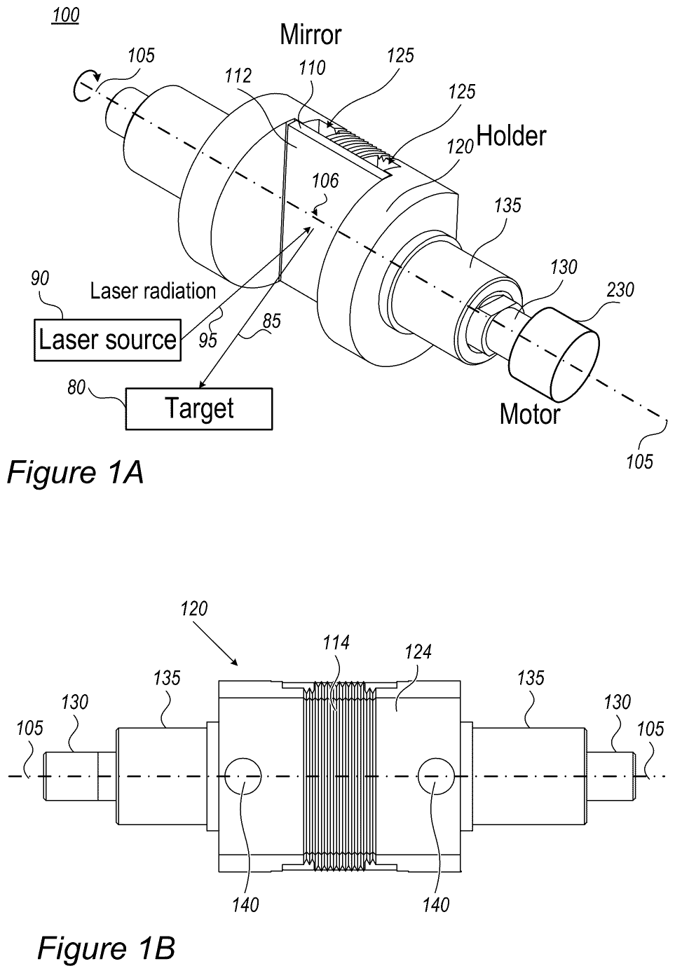

FIGS. 1A and 1B are high-level schematic illustrations of a laser scanner 100, according to some embodiments of the invention. FIG. 1A is a perspective front view and FIG. 1B is a back view of laser scanner 100, as explained herein.

Laser scanner 100 comprises a laser source 90 delivering laser radiation 95, a mirror 110 having a reflective plane 112 configured to reflect laser radiation 95 from laser source 90 as beam 85 onto a target 80, a holder 120 having a rotating axis 105, wherein mirror 110 is mounted on holder 120 with rotating axis 105 being at reflective plane 112 of mirror 110 (this condition is denoted by numeral 106), and a motor 230 configured to rotate holder 120 with mirror 110 around rotating axis 105.

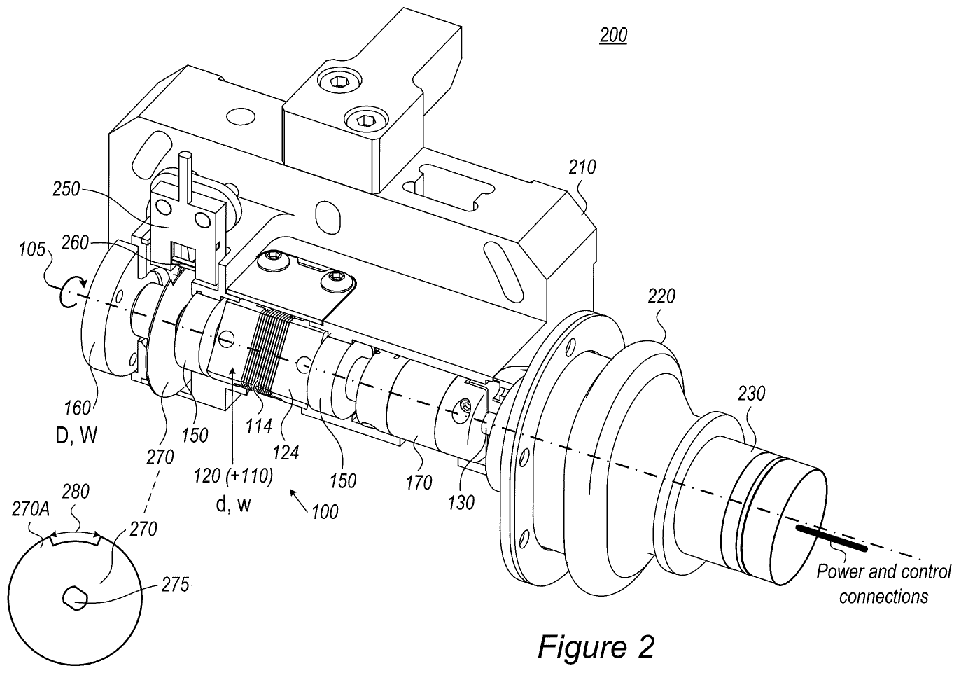

For example, motor 230 (see, e.g., FIG. 2) may apply the rotation via a motor shaft 130 that moves a bearing shaft 135 that is attached to or is part of holder 120. Holder 120 may further comprise recesses 125 (illustrated schematically in FIG. 1A) for holding and bonding mirror 110.

FIG. 1B further illustrates, on a back side 124 of holder 120 (opposite to reflective plane 112 of mirror 110), a textured back mirror surface 114 configured to scatter high power laser radiation at angles of rotation (of holder 120 about axis 105) that are not usable for laser scanning as a safety measure for cases in which the laser is not switched off during the rotation of holder 120 through positions that do not enable reflection of laser radiation 95 by reflective plane 112 of mirror 110.

In various embodiments, laser scanner 100 further comprising specified regions on side 124 of holder 120 configured for adding or removing material to balance holder 120 with mounted mirror 120 about rotating axis 105 at reflective plane 112 of mirror 110 (106). As an example of specified regions configured for this purpose, FIG. 1B further illustrates depressions 140 on back side 124 of holder 120 for adding and/or removing material to balance holder 120 with mounted mirror 110 and locate (or ensure location) of a center of mass of holder 120 with mounted mirror 110 on rotating axis 105. Accurate weight balance is required to align the center of mass of the rotating assembly (holder 120 with mounted mirror 110, and any further rotating elements disclosed herein) with rotating axis 105, in order to prevent vibrations and deviations, and maintain accuracy and reliability of laser scanner 100. Accurate weight balance may be achieved by any of the following configurations or their combinations.

In some embodiments, the mechanical design and structure of holder 120 and mirror 110 may be adjusted to yield accurate balancing, e.g., by compensating imbalances such as compensating for a shift of the center of mass of mirror 110 to one side of rotating axis 105 by an equivalent shift of the center of mass of mirror holder 120 to an opposite side of rotating axis 105 at both sides along axis 105.

In some embodiments, balancing may be accurately adjusted by addition or removal of material to or from depressions 140, as dedicated locations for accurate adjustment of the balance. For example, a balancing compound may be added to one or more depressions 140, and/or material may be drilled away or otherwise removed from one or more depressions 140. Non-limiting examples for balancing compounds may comprise epoxy-based materials (such as BC-22 from Star Technology). The configuration of depressions 140 may vary, e.g., two depressions along a parallel line to rotation axis 105 may be used, and/or additional or other locations for depressions 140 may be selected to enable accurate balancing. For example, as part of testing assembled laser scanner 100, the degree of balancing may be measured and the amount of material to be added or removed for full and accurate balancing may be calculated. Accordingly, a calculated amount of material may be added into dedicated depressions 140 in mirror holder 120 and dried until the material is solidified and combined with the holder material (e.g., stainless steel AISI304) and/or a calculated amount of material may be removed from depressions 140, e.g., by drilling, with the shape of depressions 140 configured to simplify centering the drilling elements.

FIG. 2 is a high-level schematic illustration of laser scanner 200, according to some embodiments of the invention. FIG. 2 is a perspective view of laser scanner 200 with scanner body 210, motor 230 and seal 220, in addition to laser scanner 100 with holder 120 and mirror 110 illustrated schematically in FIGS. 1A and 1B. Configurations of laser scanner 100 may be mounted into configurations of laser scanner 200 via bearings 150 or directly on motor shaft 130. Configurations of laser scanner 100 may be connected to motor 230 via a coupling 170, and motor 230 may be a direct drive motor (e.g., of the series ECX SP22L from Maxon International Ltd.).

FIG. 2 further illustrates an optional stabilization disk 160 and internal thru-beam sensor 250 with laser control disk 270 described herein. It is noted that various embodiments of laser scanners 100 illustrated schematically in FIGS. 1A and 1B may be used as the core elements of laser scanners 200 illustrated schematically in FIG. 2.

In various embodiments, laser scanner 200 may further comprise stabilization disk 160 that is mounted on rotating axis 105 and has a moment of inertia that is larger than a moment of inertia of holder 120 with mounted mirror 110. Stabilization disk 160 may be configured to stabilize the resulting rotation speed of mirror 110 around axis 105—as increasing the overall moment of inertia of the rotating assembly decreases the sensitivity to all sources of vibrations, both internal (e.g., within bearings 150 or motor 230) and external (e.g., vibrations from other parts of laser scanner 200 and surrounding area). The large moment of inertia of stabilization disk 160 may be achieved in various means, e.g., by stabilization disk 160 having a diameter (indicated schematically by D) and a weight (indicated schematically by W) that are larger, respectively, than a diameter and a weight of holder 120 with mounted mirror 110 (indicated schematically by d and w, respectively). The moment of inertia of stabilization disk 160 may be reached by making stabilization disk 160 larger and therefore heavier (e.g., larger diameter and weight than holder 120 with mirror 110) and/or making stabilization disk 160 from a heavy material (having a high specific gravity) including steel, lead, chromium, etc.

In various embodiments, laser scanner 200 may further comprise thru-beam sensor 250 to control operation of laser source 90, and control disk 270 that is mounted on rotating axis 105 and has a periphery 270A that does not interrupt thru-beam sensor 250 over a specified angular range 280 during rotation of disk 270, which lets the beam pass through to sensor 250 and enabling to switch on laser source 90. Numeral 260 indicates schematically a beam generated by thru-beam sensor 250 and interrupted by periphery 270A of disk 270 but not by specified angular range 280 thereof.

In some embodiments, control disk 270 except for specified angular range 280—may be configured to interrupt thru-beam sensor 250 at angles in which mirror 110 is required to reflect laser radiation 95 for scanning, and interrupted thru-beam sensor 250 enables laser source 90. In such embodiments, laser source 90 may be switched on when specified angular range 280 of disk 270 is not in front of thru-beam sensor 250.

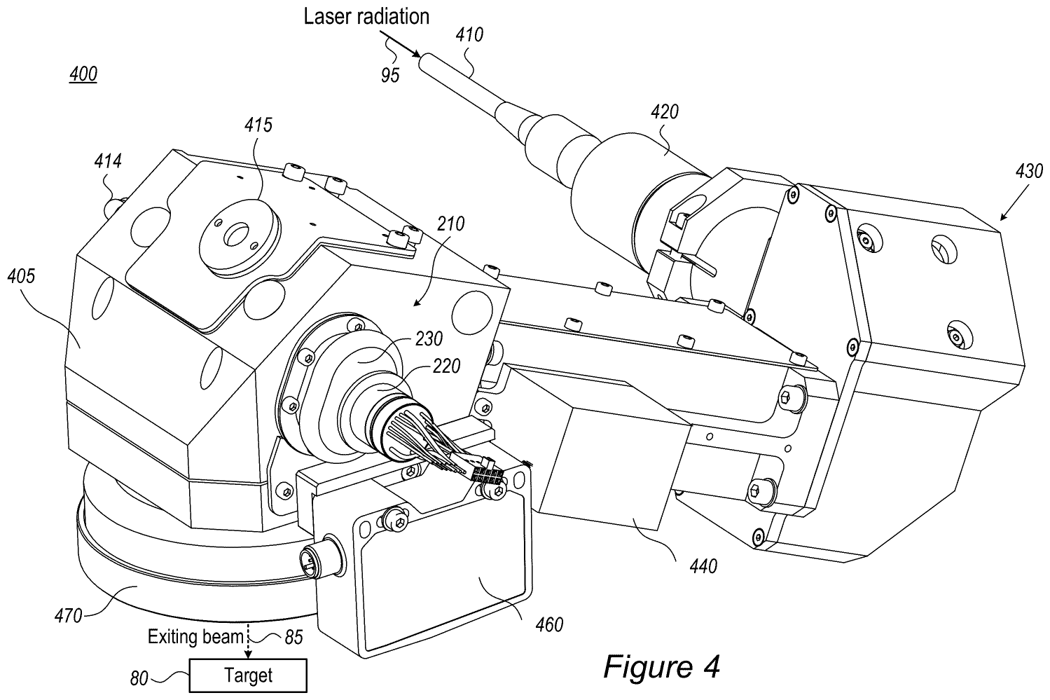

In various embodiments, spinning mirror 110 may have an angular range within ±90° to reflect laser beam 95 (to form beam 85), with corresponding incidence angles of the beam within ±90° relative to the normal to reflective plane 112 of mirror 110. In various embodiments, the angular range of reflection may be much smaller (e.g., ±60°, ±45°, ±30° or intermediate values) due to limitations of the focusing optics of beam 85 delivered by laser scanner 200 such as an F-Theta lens (see, e.g., 470 on FIG. 4). As illustrated schematically in FIG. 2, thru-beam sensor 250 and control disk 270 may be used to stop operation of laser source 90 beyond the angular range that is used for scanning laser beam 95 across target 80. Specifically, thru-beam sensor 250 and control disk 270 may be used to switch laser source 90 off when mirror 110 spins out of the effective reflective angular range. Switching off laser source 90 at unused angles enables to avoid undesired high power laser radiation dissipation within the scanner and also to save the laser lifetime. Advantageously, disclosed mechanism of thru-beam sensor 250 and control disk 270 is effective and simpler than prior art means of synchronizing the laser timing with the mirror angular position (e.g., precise motor encoders and associated electronics, which are costly and require calibration of the encoder readout to the actual position of the mirror). Specified angular range 280 on periphery 270A of disk 270 mounted on axis 105 is used to synchronize the mirror angular position relative to axis 105 with the activation of laser source 90—free angular range 280 allows defining the operation period of laser source 90 with respect to the position of mirror 110 inside or outside the effective reflective angular range. Specified angular range 280 may be configured to define on periods or off periods of laser source 90, depending on the configuration of disk 270 and thru-beam sensor 250. For example, when disk 270 crosses the beam of thru-beam sensor 250 outside angular range 280, laser source 90 may be switched OFF and when angular range 280 enables the beam of thru-beam sensor 250 to pass uninterrupted, laser source 90 may be switched ON (only at the effective reflective angular range of mirror 110). Angular range 280 of disk 270 may be aligned with respect to the angular position of mirror 110, e.g., using a D-shaped mounting hole 275 on disk 270 and a corresponding D-shape rotating shaft section, which is a part of either mirror holder 120 or motor shaft 130.

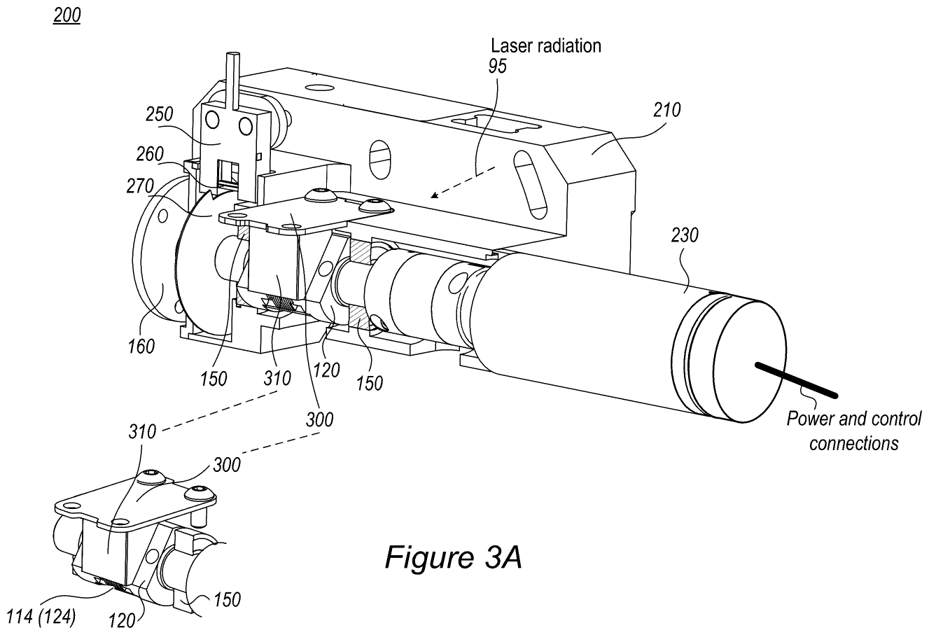

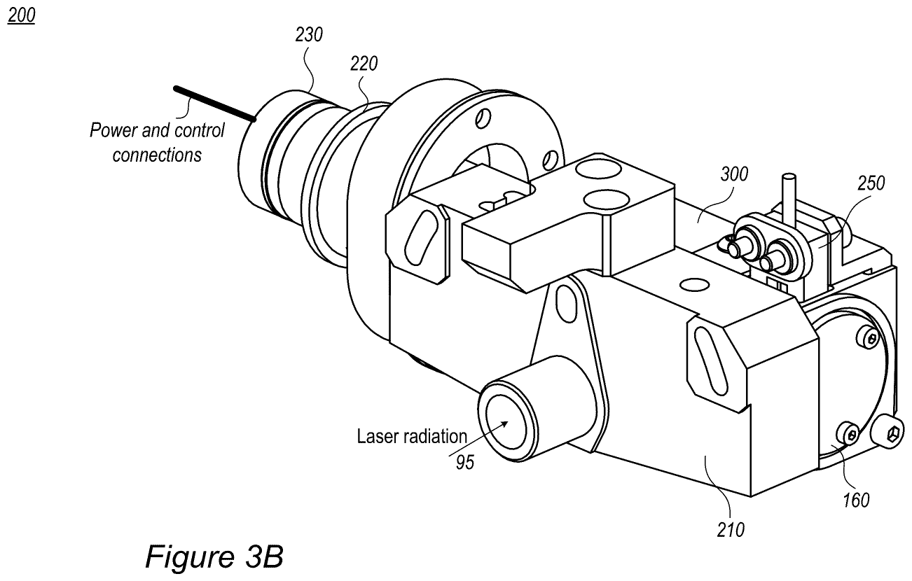

FIGS. 3A and 3B are high-level schematic illustrations of laser scanner 200 with an alignment fixture 300, according to some embodiments of the invention. FIG. 3A provides a front view and FIG. 3B provides a rear view of laser scanner 200. Laser scanner 200 may further comprise alignment fixture 300 used to temporarily affix mirror 110 in a zero angular position during a scanner alignment stage, in which laser beam location calibration is carried out relative to a scanned line.

Alignment fixture 300 may comprise a tenon 310 configured to contact mirror holder backplane 124 (see FIG. 1B) to locate front mirror plane 112 (see FIG. 1A) at the nominal angular position relative to the laser beam (zero mirror position)—to conduct the scanner alignment with mirror 110 at the pre-determined setting. Advantageously, fixture 300 enables aligning a zero position of mirror 110—to allow directing the laser beam of the scanner at a nominal angle relative to mirror front plane 112 (usually at 45°, but possibly at a different angle) and towards the center of the scanning line (as an example for target 80). Alignment fixture 300 may be further configured to remove tenon 310 from contacting back side 124 of holder 120 after alignment and during operation, to allow free rotation of holder 120 with mounted mirror 110. Advantageously, disclosed embodiments enable achieving the alignment of mirror 110 to target object 80 using a mechanical design, while keeping mirror 110 operationally free to rotate and without resorting to implementing an angular motion control, which is much more complex and costly. Alignment fixture 300 with tenon 310 (e.g., connected to fixture 300 by a tenon holder) contacts mirror holder back surface 124, e.g., at both sides of the textured back surface, and temporarily, at the system alignment stage, is mounted to scanner body 210 and affixes mirror 110 in a static zero-position. Once the laser beam alignment is complete, tenon 310 may be removed and stored on scanner body 210 for a next use. Laser radiation 95 may enter laser scanner 200 from the back (illustrated schematically in FIG. 3B) and the beam may be directed within laser scanner 200 onto mirror 110 (illustrated schematically in FIG. 3A).

FIG. 4 is a high-level schematic illustration of laser scanner 400 comprising an enclosure 405, according to some embodiments of the invention. It is noted that laser scanner 400 (including embodiments of a full laser scanner based on a rotating mirror, which includes also the laser and laser beam focusing optics) may comprise various embodiments of laser scanners 100 (including the rotating mirror sub-assembly) illustrated schematically in FIGS. 1A and 1B and/or various embodiments of laser scanners 200 (including the rotating mirror assembly with a body and sensor) illustrated schematically in FIGS. 2 and 3. It is noted that laser scanner configurations 100 and/or 200 may be implemented in different designs of full laser scanner 400, using the disclosed principles.

Any of laser scanners 100, 200 may be set within enclosure 405 (e.g., to form laser scanner 400), which may have an inlet 415 for purging an internal volume of laser scanner 400 with clean air or gas (e.g., clean pressed air—CPA, or clean gas, e.g., nitrogen) to avoid contamination of mirror 110. Enclosure 405 may fully or partly seal spinning mirror 110 and holder 120 (see seal 220) except for CPA purge inlet 414 and outlet 415 (e.g., outlet 415 may comprise a one-way valve with a specified break point).

FIG. 4 further illustrates a beam delivery unit 430 comprising two mirrors for accurate beam alignment and other optional optical components (internal, not shown), as well as a laser beam collimator 420 and a fiber of a fiber laser 410 (e.g., from or as laser source 90 delivering laser beam 95, e.g., through aperture 320 illustrated in FIGS. 3A and 3B).

Optionally, laser scanner 400 may further comprise a laser distance sensor 460 configured to accurately measure the distance between scanner 400 and the receiving substrate of target 80, and maintain or adjust the distance to be within predefined specifications, e.g., in the range between 50 μm-500 μm, to reach specified printing quality and resolution requirements.

Laser scanner 400 may further comprise a motor driver 440 which may include a motor controller, such as e.g., EPOS4 Compact 50/5 CAN controller and driver from Maxon International Ltd.

In some embodiments, rotation of mirror 110 about rotating axis 105 may be employed for fast scanning, and laser scanner 400 may further comprise a mechanical motion system (not illustrated) to move scanner 400 for scanning along an orthogonal slow scanning axis—to yield two-dimensional scanning. Accordingly, disclosed precise and fast 1D spinning mirror scanners configurations 100, 200, 400 may be used to implement 2D scanners by adding a slow movement axis, e.g., (i) using a linear motor axis, configured to move the 1D scanner in the orthogonal direction, or (ii) using a second scanning mirror such as a galvanometer (galvo) scanner to implement the slow axis is the orthogonal direction.

Laser scanner 400 may further comprise a F-Theta lens 470 and/or other optical means to focus laser beam 85 exiting laser scanner 400 (after reflection of laser beam 95 by mirror 110).

Any of laser scanner configurations 100, 200, 400 may be used in a pattern transfer printing (PTP) system, configured to apply patterns of conductive material onto wafers by non-contact printing. For example, trenches in pattern transfer sheets (e.g., on a continuous pattern transfer tape) may be filled with conductive paste, which, upon scanning the trenches by laser scanner 400, are released from the trenches onto adjacent wafers, as described, e.g., in U.S. Pat. No. 11,910,537, incorporated herein by reference in its entirety.

Advantageously, high scanning speed and precise location of the focused beams provided by spinning mirror scanner configurations 100, 200, 400 are important features for different industrial laser-based processing systems in which high spatial resolution is required and are especially valuable for high resolution laser printing systems. For example, spinning mirror scanner 400 may be very efficient for PTP systems, in which they enable a small high-power laser beam to scan very narrow trenches in a tape carrier or sheets filled by the conductive paste.

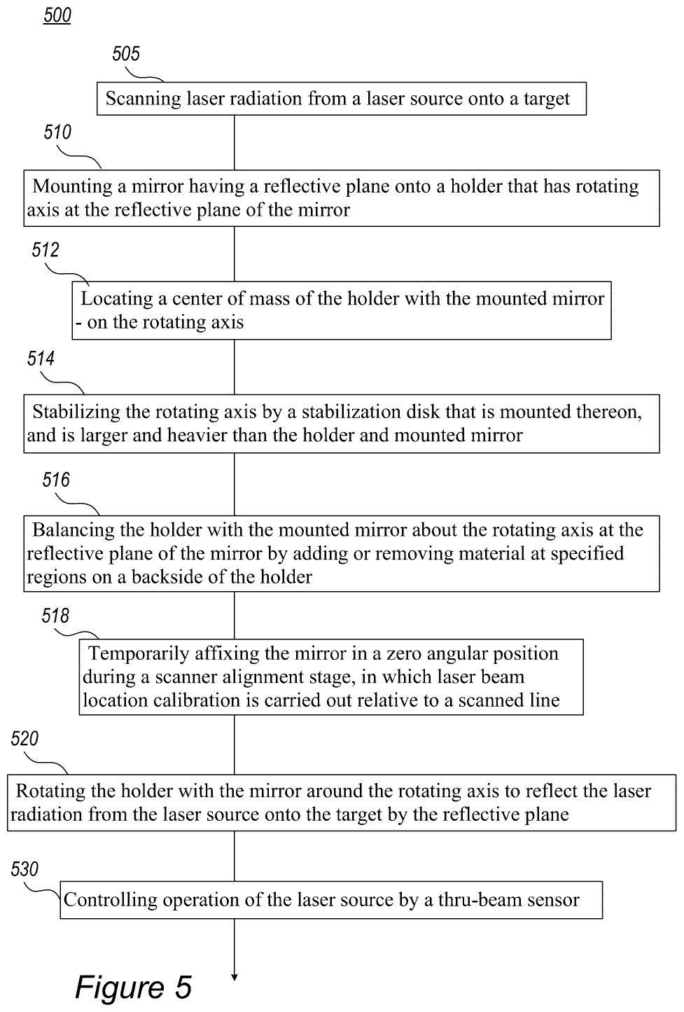

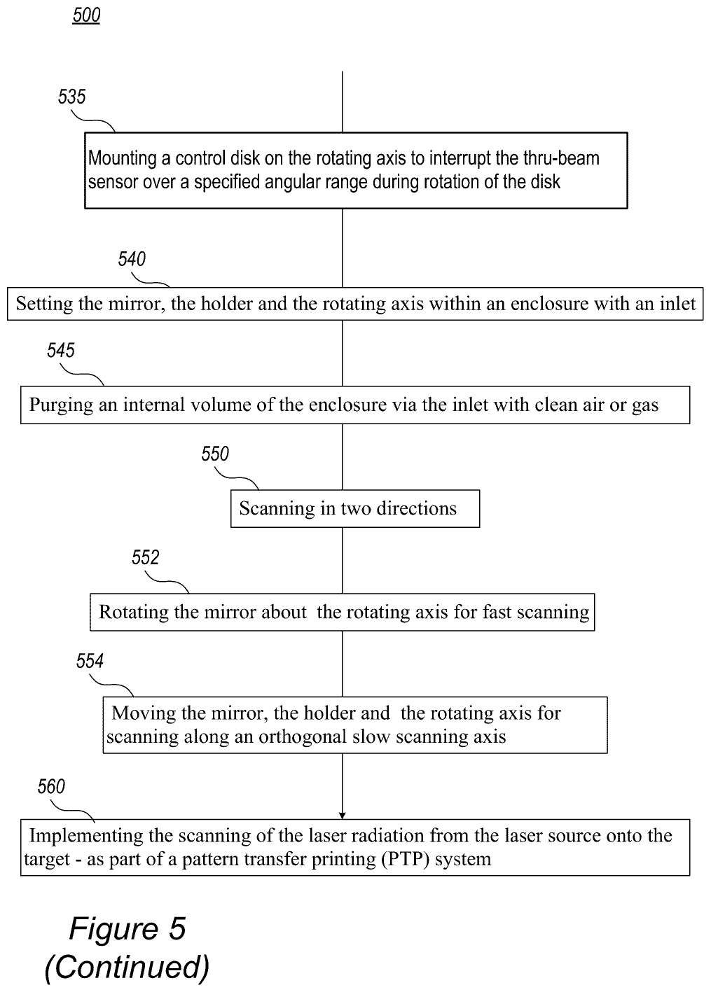

FIG. 5 is a high-level flowchart illustrating a method 200, according to some embodiments of the invention. The method stages may be carried out with respect to laser scanners 100, 200, 400 described above, which may optionally be configured to implement method 200. Method 500 may be at least partially implemented by at least one computer processor, e.g., in a controller of laser scanners 100, 200, 400. Certain embodiments comprise computer program products comprising a computer readable storage medium having computer readable program embodied therewith and configured to carry out the relevant stages of method 500. Method 500 may comprise the following stages, irrespective of their order.

Method 500 of scanning laser radiation from a laser source onto a target (stage 505) may comprise mounting a mirror onto a holder, wherein the mirror has a reflective plane and the holder has a rotating axis at the reflective plane of the mirror (stage 510), and rotating the holder with the mirror around the rotating axis to reflect the laser radiation from the laser source onto the target by the reflective plane (stage 520).

Method 500 may further comprise locating a center of mass of the holder with the mounted mirror—on the rotating axis (stage 512). In certain embodiments, method 500 may further comprise stabilizing the rotating axis by a stabilization disk that is mounted thereon, and has a larger moment of inertia, e.g., is larger and heavier—than the holder and mounted mirror (stage 514).

In certain embodiments, method 500 may further comprise controlling operation of the laser source by a thru-beam sensor (stage 530), e.g., by mounting a control disk on the rotating axis to interrupt the thru-beam sensor over a specified angular range during rotation of the disk (stage 535). For example, method 500 may comprise configuring the interrupting angular range to correspond to angles in which the mirror is not required to reflect the laser radiation for scanning—and disabling the laser source by the thru-beam sensor during the interruption.

In certain embodiments, method 500 may further comprise balancing the holder with the mounted mirror about the rotating axis at the reflective plane of the mirror by adding or removing material at specified regions on a backside of the holder (e.g., stage 516). In various embodiments, finely balancing the holder with the mounted mirror about the rotating axis at the reflective plane of the mirror 516 may further comprise, e.g., carrying out wobble measurement, calculating needed mass adding/removing, adding/removing the needed mass in the dedicated depressions and verifying the reached balancing by repeated wobble measurement.

In certain embodiments, method 500 may further comprise temporarily affixing the mirror in a zero angular position during a scanner alignment stage, in which laser beam location calibration is carried out relative to a scanned line (stage 518).

In certain embodiments, method 500 may further comprise setting at least the mirror, the holder and at least part of the rotating axis within an enclosure with an inlet (stage 540), and purging an internal volume of the enclosure via the inlet with clean air or gas (stage 545).

In certain embodiments, method 500 may further comprise scanning in two directions (stage 550) by rotating the mirror about the rotating axis for fast scanning (stage 552), and moving at least the mirror, the holder and at least part of the rotating axis—for scanning along an orthogonal slow scanning axis (stage 554).

In certain embodiments, method 500 may further comprise implementing the scanning of the laser radiation from the laser source onto the target—as part of a pattern transfer printing (PTP) system (stage 560), e.g., wherein the target comprises tape trenches filled by a paste.

Elements from FIGS. 1A-5 may be combined in any operable combination, and the illustration of certain elements in certain figures and not in others merely serves an explanatory purpose and is non-limiting.

Advantageously, disclosed scanners are simpler in structure (providing inherent advantages over polygon mirrors, acousto-optical deflectors—AODs) and are less limited in performance compared to other designs—e.g., more accurate than polygon mirrors, have a more uniform scanning speed compared with resonant mirrors and have broader spectral ranges than AODs, broader frequency ranges than galvanometric mirrors, and broader angular ranges (and larger mirrors) than MEMS mirrors. While spinning mirrors are known to provide high accuracy of the laser beam location on the scanning area, prior art designs are deficient with respect to multiple design aspects, including the exact positioning and balancing of the mirror, stabilization of mirror movements and preventing mirror vibrations, the coordination between the laser source and the rotation of the mirror, and maintaining the cleanliness of the mirror. Advantageously, disclosed scanners solve these technical problems as disclosed above, providing an accurate and reliable spinning mirror laser scanner for various uses.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A laser scanner that receives laser radiation from a laser source, the laser scanner comprising:
a mirror having a reflective plane configured to reflect the laser radiation from the laser source onto a target;
a holder having a rotating axis, wherein the mirror is mounted on the holder with the rotating axis being at the reflective plane of the mirror; and
a motor configured to rotate the holder with the mirror around the rotating axis,
wherein a center of mass of the holder with the mounted mirror is located on the rotating axis.

2. The laser scanner of claim 1, further comprising specified regions on a backside of the holder for adding or removing material to balance the holder with the mounted mirror about the rotating axis at the reflective plane of the mirror.

3. The laser scanner of claim 1, further comprising a stabilization disk mounted on the rotating axis having a moment of inertia larger than a moment of inertia of the holder with the mounted mirror.

4. The laser scanner of claim 1, further comprising:
a thru-beam sensor to control operation of the laser source; and
a control disk that is mounted on the rotating axis and has a periphery that interrupts the thru-beam sensor over a specified angular range during rotation of the disk,
wherein the control disk, except for the specified angular range, is configured to interrupt the thru-beam sensor at angles in which the mirror is not required to reflect the laser radiation for scanning, and the interrupted thru-beam sensor disables the laser source.

5. The laser scanner of claim 1, further comprising:
a thru-beam sensor to control operation of the laser source and
a control disk that is mounted on the rotating axis and has a periphery that interrupts the thru-beam sensor over a specified angular range during rotation of the disk,
wherein the control disk, except for the specified angular range, is configured to interrupt the thru-beam sensor at angles in which the mirror is required to reflect the laser radiation for scanning, and the interrupted thru-beam sensor enables the laser source.

6. The laser scanner of claim 1, further comprising a temporarily-used alignment fixture to temporarily affix the mirror in a zero angular position during a scanner alignment stage, in which laser beam location calibration is carried out relative to a scanned line.

7. The laser scanner of claim 1, set within an enclosure with an inlet for purging an internal volume of the laser scanner with clean air or gas.

8. The laser scanner of claim 1, wherein rotating the mirror about the rotating axis is employed for fast scanning, and the laser scanner further comprises a mechanical motion system to move the scanner for scanning along an orthogonal slow scanning axis to yield two-dimensional scanning.

9. A pattern transfer printing (PTP) system comprising the laser scanner of claim 1, configured to scan tape trenches filled by a paste.

10. A method of scanning laser radiation from a laser source onto a target, the method comprising:
mounting a mirror onto a holder, wherein the mirror has a reflective plane and the holder has a rotating axis at the reflective plane of the mirror;
rotating the holder with the mirror around the rotating axis to reflect the laser radiation from the laser source onto the target by the reflective plane; and
locating a center of mass of the holder with the mounted mirror—on the rotating axis.

11. The method of claim 10, further comprising balancing the holder with the mounted mirror about the rotating axis at the reflective plane of the mirror by adding or removing material at specified regions on a backside of the holder.

12. The method of claim 10, further comprising stabilizing the rotating axis by a stabilization disk that is mounted thereon, and has a larger moment of inertia than the holder and the mounted mirror.

13. The method of claim 10, further comprising:
controlling operation of the laser source by a thru-beam sensor, and
mounting a control disk on the rotating axis to interrupt the thru-beam sensor over a specified angular range during rotation of the disk, in which the mirror is not required to reflect the laser radiation for scanning,
wherein the interrupting of the thru-beam sensor disables the laser source.

14. The method of claim 10, further comprising temporarily affixing the mirror in a zero angular position during a scanner alignment stage, in which laser beam location calibration is carried out relative to a scanned line.

15. The method of claim 10, further comprising:
setting at least the mirror, the holder and at least part of the rotating axis within an enclosure with an inlet, and
purging an internal volume of the enclosure via the inlet with clean air or gas.

16. The method of claim 10, further comprising scanning in two directions by:
rotating the mirror about the rotating axis for fast scanning, and
moving at least the mirror, the holder and at least part of the rotating axis—for scanning along an orthogonal slow scanning axis.

17. The method of claim 10, further comprising implementing the scanning of the laser radiation from the laser source onto the target as part of a pattern transfer printing (PTP) system, wherein the target comprises tape trenches filled by a paste.
